(19) United States
(12) Patent Application Publication
(10) Pub. No.: US 2026/0347581 A1
(43) Pub. Date: Nov. 5, 2026

(54) FOAMED ARTICLE

(71) Applicant: SABIC GLOBAL TECHNOLOGIES B.V., Bergen op Zoom (NL)

(72) Inventors: Maykel PEPELS, Geleen (NL); Maikel RENDERS, Valkenswaard (NL)

(21) Appl. No.: 19/119,965

(22) PCT Filed: Oct. 12, 2023
(86) PCT No.: PCT/EP2023/078326

§ 371 Date: Apr. 10, 2025

(30) Foreign Application Priority Data
Oct. 14, 2022 (EP) 22201721.2

(51) Int. Cl. C08L 23/0807; C08J 9/00

(52) U.S. Cl. CPC C08L 23/0815; C08J 9/0061; C08J 2323/08; C08J 2423/06; C08L 2203/14; C08L 2205/025; C08L 2205/24; C08L 2207/062; C08L 2207/066

(57) ABSTRACT

A foamed article including a polyolefin composition having a density of ≥0.940 and ≤0.970 g/cm³ determined in accordance with ISO 1183-1 (2019), wherein the polyolefin composition includes
a high density polyethylene composition having a density of >0.940 and ≤0.970 g/cm³ determined in accordance with ISO 1183-1 (2019) and
a low density polyethylene composition having a density of ≥0.917 and <0.940 g/cm³ determined in accordance with ISO 1183-1 (2019),
   wherein the high density polyethylene composition includes polypropylene and the amount of polypropylene with regard to the total weight of the polyolefin composition is ≥0.01 and ≤15.0 wt %, for example ≥0.1 and ≤15.0 wt %, preferably ≥0.1 and ≤10.0 wt %, more preferably ≥0.1 and ≤7.5 wt %, more preferably ≥0.1 and ≤5.0 wt %, more preferably ≥0.1 and ≤3.0 wt %.

### CROSS-REFERENCE TO RELATED APPLICATIONS

This application is a National Stage application of PCT/EP2023/078326, filed Oct. 12, 2023, which claims the benefit of European Application No. 22201721.2, filed Oct. 14, 2022, both of which are incorporated by reference in their entirety herein.

### BACKGROUND

The invention relates to a foamed article comprising a polyolefin composition as well as to a process for the preparation of such foamed article.

Polymer foams are used in a wide range of applications, such as building and construction, automotive applications, household applications, such as food packaging and protective packaging; and consumer applications. Foams are popular because of their good mechanical rigidity, their good insulative properties and their cushioning against mechanical shock. In addition, the use of foams provides a significant contribution to the reduction in the use of raw materials. Moreover, the use of foams allows for a lightweight solution, which is not only of advantage from a cost perspective, but also from a transportation point of view as less energy is required to transport a lighter material.

For reason for increasing sustainability awareness, there is an increasing demand for a reduction in the use of virgin plastics and the use of recycled materials also for the manufacturing of foamed articles. However, recycled materials comprise impurities which may affect the stability of the foaming process and the achievable density. Impurities may further affect visual appearance and mechanical properties of the obtained foamed article.

EP3088452A1 discloses a molded foam molded by clamping, by split mold blocks, a foamed resin obtained by melting and kneading a polyethylene-based resin, wherein the molded foam has a MFR (190 °C, g/10 min) of less than 0.8. EP3088452A1 does not mention the use of a recycled polyethylene as the polyethylene-based resin for making the molded foam.

EP1449634A1 discloses a method for manufacturing a foam-molded article by molding between molds a parison with a foam layer formed by extruding an expandable molten resin composition comprising polyethylene. EP1449634A1 does not mention the use of a recycled polyethylene as the polyethylene for making the molded foam.

EP2246175A1 discloses a polyethylene resin foamed blow molded article obtained by extruding a foamable resin melt containing a physical blowing agent through a die to form a foamed parison, subsequently inserting the foamed parison in a mold, and blow molding the foamed parison. EP2246175A1 does not mention a foamable resin melt comprising polypropylene.

WO2021025578A1 discloses an article produced by foaming a polyethylene composition comprising 20 to 84 wt % of LDPE, 10 to 70 wt % of HDPE, 5 to 25 wt % of LLDPE, 0.5 to 10 wt % of polypropylene and 0 to 2 wt % of other additives. WO2021025578A1 does not mention the use of a recycled polyethylene as the polyethylene for making the molded foam.

It is an object of the present invention to provide a foamed article in which the above-mentioned and/or other problems are solved.

### SUMMARY

Accordingly, the invention provides a foamed article comprising a polyolefin composition having a density of ≥0.940 and ≤0.970 g/cm³ determined in accordance with ISO 1183-1 (2019), wherein the polyolefin composition comprises
a high density polyethylene composition having a density of >0.940 and ≤0.970 g/cm³ determined in accordance with ISO 1183-1 (2019) and
a low density polyethylene composition having a density of ≥0.917 and <0.940 g/cm³ determined in accordance with ISO 1183-1 (2019),
   wherein the high density polyethylene composition comprises polypropylene and the amount of polypropylene with regard to the total weight of the polyolefin composition is ≥0.01 and ≤15.0 wt %, for example ≥0.1 and ≤15.0 wt %, preferably ≥0.1 and ≤10.0 wt %, more preferably ≥0.1 and ≤7.5 wt %, more preferably ≥0.1 and ≤5.0 wt %, more preferably ≥0.1 and ≤3.0 wt %.

The invention provides a foamed article comprising a polyolefin composition having a density of ≥0.940 and ≤0.970 g/cm³ determined in accordance with ISO 1183-1 (2019), wherein the polyolefin composition comprises
a high density polyethylene composition having a density of >0.940 and ≤0.970 g/cm³ determined in accordance with ISO 1183-1 (2019) and
a low density polyethylene composition having a density of ≥0.917 and <0.940 g/cm³ determined in accordance with ISO 1183-1 (2019),
   wherein the high density polyethylene composition comprises polypropylene and the amount of polypropylene with regard to the total weight of the polyolefin composition is ≥0.01 and ≤15.0 wt %, for example ≥0.1 and ≤15.0 wt %, preferably ≥0.1 and ≤10.0 wt %, more preferably ≥0.1 and ≤7.5 wt %, more preferably ≥0.1 and ≤5.0 wt %, more preferably ≥0.1 and ≤3.0 wt %,
   wherein
   the high density polyethylene composition comprises a high density propylene having a density of >0.940 and ≤0.970 g/cm³ determined in accordance with ISO 1183-1 (2019) in an amount of ≥95.0 wt % with regard to the high density polyethylene composition,
   the amount of low density polyethylene with regard to the total weight of the low density polyethylene composition is at least 95 wt %,
   the total amount of the high density polyethylene composition, the low density polyethylene composition, an optional nucleating agent and optional additives with regard to the total weight of the polyolefin composition is 100 wt %.

Preferably, the polyolefin composition comprises less than 5.0 wt % of linear low density polyethylene (LLDPE), more preferably less than 4.0 wt %, less than 3.0 wt %, less than 2.0 wt %, less than 1.0 wt %, less than 0.5 wt %, less than 0.1 wt % or 0.0 wt % of LLDPE.

Preferably, the total amount of high density polyethylene having a density of >0.940 and ≤0.970 g/cm³ determined in accordance with ISO 1183-1 (2019), low density polyethylene and polypropylene with regard to the total weight of the polyolefin composition is more than 95 wt %, at least 96 wt %, at least 97 wt %, at least 98 wt % or at least 99 wt %.

Preferably, the total amount of high density polyethylene having a density of >0.940 and ≤0.970 g/cm³ determined in accordance with ISO 1183-1 (2019) and low density polyethylene with regard to the total weight of the polyolefin composition is more than 95 wt %, at least 96 wt %, at least 97 wt %, at least 98 wt % or at least 99 wt %.

### DETAILED DESCRIPTION

The polyolefin composition used for making the foamed article according to the invention comprises a high density polyethylene composition and a low density polyethylene composition. It has been found that, although the high density polyethylene composition comprises polypropylene, the presence of the low density polyethylene composition in the polyolefin composition allows achieving a low foam density of the foamed article and allows a stable foaming process over a relatively broad range of processing temperature.

### HDPE Composition

Since the presence of polypropylene is allowed in the high density polyethylene composition used in the present invention, the high density polyethylene composition can advantageously be or comprise a post-consumer recycled composition. The term “post-consumer recycled composition” is understood to mean that the composition has been obtained from a mechanically recycled stream originating from consumer waste plastics.

High density polyethylene compositions being or comprising a post-consumer recycled composition are commercially available and can obtained e.g. from SABIC or Morssinckhof.

The amount of polypropylene with regard to the total weight of the polyolefin composition is ≥0.01 and ≤15.0 wt %, for example ≥0.1 and ≤15.0 wt %, preferably ≥0.1 and ≤10.0 wt %, more preferably ≥0.1 and ≤7.5 wt %, more preferably ≥0.1 and ≤5.0 wt %, more preferably ≥0.1 and ≤3.0 wt %

Preferably, the amount of polypropylene with regard to the total weight of the high density polyethylene composition is ≥0.01 and ≤20.0 wt %, for example ≥0.1 and ≤20.0 wt %, ≥0.1 and ≤15.0 wt %, preferably ≥0.1 and ≤10.0 wt %, more preferably ≥0.1 and ≤7.5 wt %, more preferably ≥0.1 and ≤5.0 wt %, more preferably ≥0.1 and ≤3.0 wt %.

Impurities other than polypropylene can be present in the high density polyethylene composition. In some embodiments, the high density polyethylene composition comprises polyethylene terephthalate, e.g. in an amount of ≥0.01 wt % and ≤1.0 wt % with regard to the high density polyethylene composition. Alternatively or additionally, the high density polyethylene composition can comprise ≥0.01 wt % and ≤1.0 wt % of C4 moieties, ≥0.01 wt % and ≤1.0 wt % of C6 moieties and/or ≥0.01 wt % and ≤1.0 wt % of C8 moieties, with regard to the high density polyethylene composition. The presence and amounts of polypropylene, polyethylene terephthalate, C4 moieties, C6 moieties and C8 moieties in the high density polyethylene composition can be determined by 13C NMR, e.g. by the specific method described in the experimental section of the present disclosure.

Preferably, the majority of the high density polyethylene composition is high density polyethylene. Preferably, the high density polyethylene composition comprises a high density propylene having a density of >0.940 and ≤0.970 g/cm³ determined in accordance with ISO 1183-1 (2019) in an amount of ≥75.0 wt %, for example ≥80.0 wt %, ≥90.0 wt %, ≥93.0 wt % or ≥95.0 wt %, with regard to the high density polyethylene composition.

The high density polyethylene composition may further comprise additives, such as for example flame retardants, pigments, lubricants, slip agents flow promoters, antistatic agents, processing stabilizers, long term stabilisers and/or UV stabilizers.

Preferably, the amount of the high density polyethylene composition with regard to the total weight of the polyolefin composition is 60 to 99 wt %, more preferably 61 to 95 wt %, more preferably 62 to 90 wt %, more preferably 63 to 85 wt %, more preferably 64 to 80 wt %, more preferably 65 to 75 wt %.

### LDPE Composition

The low density polyethylene composition comprises a low density polyethylene.

Preferably, the amount of the low density polyethylene with regard to the total weight of the low density polyethylene composition is at least 95 wt %, at least 97 wt %, at least 98 wt %, at least 99 wt % or 100 wt %.

The low density polyethylene composition may further comprise additives, such as for example flame retardants, pigments, lubricants, slip agents flow promoters, antistatic agents, processing stabilizers, long term stabilisers and/or UV stabilizers. Preferably, the total amount of the low density polyethylene and the additives is 100 wt % with respect to the low density polyethylene composition.

The low density polyethylene may be produced by use of autoclave technology or by tubular reactor technology.

The low density polyethylene may be an ethylene homopolymer or may comprise a comonomer, for example 1-butene or 1-hexene.

Preferably, the low density polyethylene has a density determined in accordance with ISO 1183-1 (2019) of <0.940 g/cm³, preferably ≥0.917 and <0.940 g/cm³, preferably ≥0.920 and <0.930 g/cm³.

Preferably, the low density polyethylene composition has a density determined in accordance with ISO 1183-1 (2019) of ≥0.917 and <0.940 g/cm³, preferably ≥0.920 and <0.930 g/cm³.

Preferably, the low density polyethylene composition has a melt mass-flow rate as determined in accordance with ISO 1133-1 (2011) at 190 °C and 2.16 kg load of ≥0.10 and ≤5.0 g/10 min, preferably ≥0.10 and ≤3.0 g/10 min, preferably ≥0.15 and ≤2.0 g/10 min.

Preferably, the amount of the low density polyethylene composition with regard to the total weight of the polyolefin composition is 1 to 40 wt %, more preferably 5 to 39 wt %, more preferably 10 to 38 wt %, more preferably 15 to 37 wt %, more preferably 20 to 36 wt %, more preferably 25 to 35 wt %.

Preferably, the total amount of the high density polyethylene composition and the low density polyethylene composition with regard to the total weight of the polyolefin composition is at least 80 wt %, at least 90 wt %, at least 95 wt %, at least 97 wt %, at least 98 wt %, at least 99 wt % or 100 wt %.

The production processes of HDPE and LDPE are summarised in Handbook of Polyethylene by Andrew Peacock (2000; Dekker; ISBN 0824795466) at pages 43-66.

### Nucleating Agent

The polyolefin composition may further comprise a nucleating agent. A nucleating agent may be desired to increase the cell density and to modify the dynamics of bubble formation and growth. (Gendron, Thermoplastic foam Processing, 2005, page 209). The amount of nucleating agent may for example be ≥0.010 wt % and ≤5.0 wt %, for example ≥0.030 wt % and ≤4.0 wt %, for example ≥0.050 wt % and ≤3.0 wt %, preferably ≥0.10 wt % and ≤2.5 wt %, more preferably ≥0.30 wt % and ≤1.5 wt % based on the polyolefin composition, most preferably ≥0.50 wt % and ≤1.2 wt % based on the polyolefin composition.

Suitable nucleating agents include but are not limited to talc, silica and a mixture of sodium bicarbonate and citric acid. Other suitable nucleating agents include amides, for example azo dicarbonamide, amines and/or esters of a saturated or unsaturated aliphatic (C₁₀-C₃₄) carboxylic acid. Examples of suitable amides include fatty acid (bis)amides such as for example stearamide, caproamide, caprylamide, undecylamide, lauramide, myristamide, palmitamide, behenamide and arachidamide, hydroxystearamides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide, ethylene bisbehenamide and mixtures thereof. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Preferably, the nucleating agent is chosen from the group of talc, sodium bicarbonate, citric acid, azodicarbonamide and mixtures thereof, more preferably, the nucleating agent is talc.

For the preparation of the foamed article, it may be desired to use a cell stabilizer. Cell stabilizers are permeability modifiers which retard the diffusion of for example hydrocarbons such as isobutane to create dimensionally stable foams. (Gendron, Thermoplastic foam Processing, 2005, pages 31 and 149) Preferred cell stabilizers include but are not limited to glycerol monostearate (GMS), glycerol monopalmitate (GMP), palmitides and/or amides. Suitable amides are for example stearyl stearamide, palmitide and/or stearamide. Suitable mixtures include for example a mixture comprising GMS and GMP or a mixture comprising stearamide and palmitamide. Preferably, in case a cell stabilizer is used, the cell stabilizer is glycerol monostearate or stearamide.

The amount of cell stabilizer to be added depends on desired cell size and the polyolefin composition used for the preparation of the foamed article. Generally, the cell stabiliser may be added in an amount ≥0.10 and ≤3.0 wt % relative to the polyolefin composition.

Preferably, the total amount of the high density polyethylene composition, the low density polyethylene composition, the nucleating agent with regard to the total weight of the polyolefin composition is at least 80 wt %, at least 90 wt %, at least 95 wt %, at least 97 wt %, at least 98 wt %, at least 99 wt % or 100 wt %.

### Additives

The polyolefin composition may further comprise additives, such as for example flame retardants, pigments, lubricants, slip agents flow promoters, antistatic agents, processing stabilizers, long term stabilisers and/or UV stabilizers. The additives may be present in any desired amount to be determined by the man skilled in the art, but are preferably present ≥0.001 wt % and ≤5.0 wt %, more preferably ≥0.01 wt % and ≤4.0 wt %, even more preferably ≥0.01 wt % and ≤3.0 wt %, even more preferably ≥0.01 wt % and ≤2.0 wt % based on the polyolefin composition.

Preferably, the total amount of the high density polyethylene composition, the low density polyethylene composition, the nucleating agent and the additives with regard to the total weight of the polyolefin composition is 100 wt %.

### Polyolefin Composition

In some preferred embodiments, the polyolefin composition has a melt mass-flow rate as determined in accordance with ISO 1133-1 (2011) at 190 °C and 2.16 kg load (hereinafter sometimes referred as MFR2) of ≥0.05 and ≤10.0 g/10 min, preferably of ≥0.10 and ≤8.0 g/10 min, preferably of ≥0.10 and ≤4.0 g/10 min, more preferably of ≥0.10 and ≤2.0 g/10 min, more preferably of ≥0.10 and ≤1.0 g/10 min. In some preferred embodiments, the polyolefin composition has a melt mass-flow rate as determined in accordance with ISO 1133-1 (2011) at 190 °C and 2.16 kg load of ≥0.30 and ≤5.0 g/10 min, of ≥0.50 and ≤4.0 g/10 min, of ≥1.5 and ≤3.0 g/10 min.

In some preferred embodiments, the polyolefin composition has a melt mass-flow rate as determined in accordance with ISO 1133-1 (2011) at 190 °C and 5.0 kg load (hereinafter sometimes referred as MFR5) of ≥0.10 and ≤15.0 g/10 min, preferably of ≥0.15 and ≤8.0 g/10 min, preferably of ≥0.20 and ≤4.0 g/10 min, more preferably of ≥0.25 and ≤3.0 g/10 min, more preferably of ≥0.30 and ≤2.0 g/10 min. In some preferred embodiments, the polyolefin composition has a melt mass-flow rate as determined in accordance with ISO 1133-1 (2011) at 190 °C and 5 kg load of ≥0.50 and ≤8.0 g/10 min, of ≥1.0 and ≤6.0 g/10 min, of ≥2.0 and ≤4.0 g/10 min.

In some preferred embodiments, the polyolefin composition has a melt mass-flow rate as determined in accordance with ISO 1133-1 (2011) at 190 °C and 21.6 kg load (hereinafter sometimes referred as MFR21) of ≥5.0 and ≤50 g/10 min, of ≥7.0 and ≤45.0 g/10 min, preferably of ≥10.0 and ≤40.0 g/10 min, more preferably of ≥15.0 and ≤35.0 g/10 min. In some preferred embodiments, the polyolefin composition has a melt mass-flow rate as determined in accordance with ISO 1133-1 (2011) at 190 °C and 21.6 kg load of ≥10.0 and ≤350.0 g/10 min, of ≥20.0 and ≤250.0 g/10 min, of ≥40.0 and ≤100.0 g/10 min.

Preferably, MFR21/MFR2 is 10 to 500, 20 to 400, 30 to 350 or 40 to 300.

### Foamed Article

In the context of the invention, with ‘foamed’ or ‘foam’ is meant that the shape has a lower density due to the presence of gas bubbles (such as air) as compared to the density of the same material without gas bubbles.

Preferably, the polyolefin composition is present in the foamed article in an amount ≥80 to 99.9 wt % based on the foamed article. For example, the polyolefin composition is present in the foamed article in an amount ≥85 wt %, ≥90 wt %, ≥95 wt %, ≥96 wt %, ≥97 wt %, ≥98 wt %, ≥99 wt %, ≥99.5 wt % based on the foamed article. The foamed article may also consist of the polyolefin composition.

Preferably, the foamed article has a foam density of ≥0.03 and ≤0.90 g/cm³, preferably ≥0.05 and ≤0.90 g/cm³, preferably ≥0.10 and ≤0.90 g/cm³, preferably ≥0.20 and ≤0.80 g/cm³, preferably 0.22 and ≤0.75 g/cm³, preferably 0.25 and ≤0.60 g/cm³, preferably 0.30 and ≤0.50 g/cm³ as determined in accordance with the method of ISO 845 (2006).

Preferably, the foamed article has an open cell content of ≤15.0%, preferably ≤12.0%, more preferably ≤10.0%, even more preferably ≤7.0%, even more preferably ≤5.0%, even more preferably ≤4.0%, even more preferably ≤3.0%, even more preferably ≤2.0%, wherein the open cell content is determined according to ASTM D6226-10.

Preferably, the foamed article is a foamed sheet. A sheet as defined herein is a shape which has a longer length than width, and a larger width than thickness. The thickness of the sheet is in principle not critical, but may for example be ≥50 μm and ≤100 cm, for example ≥0.10 mm and ≤10 cm, ≥0.15 mm and ≤5.0 cm, ≥0.20 mm and ≤3.0 cm, ≥0.1 mm and ≤1.0 cm or ≥0.3 and ≤1.0 mm. The thickness of the sheet may for example be ≥50 μm and ≤1.0 mm, >1.0 mm and ≤10 cm or ≥10 cm and ≤50 cm.

### Process

The invention further provides a process for the preparation of the foamed article according to the invention, comprising the sequential steps of:
a) providing the polyolefin composition,
b) adding a blowing agent to the polyolefin composition, for example wherein the blowing agent is added in an amount ≥0.10 wt % and ≤20 wt % based on the polyolefin composition and
c) subjecting the mixture of the polyolefin composition and the blowing agent to a foaming process.

In some preferred embodiments, the foamed article is a foamed sheet.

Processes for the preparation of polyolefin foams and foamed sheets are within the knowledge of the person skilled in the art. In such a process, a melt of a polyolefin composition mixed with a gaseous or liquid blowing agent is suddenly expanded through a pressure drop. Continuous foaming processes as well as discontinuous processes may be applied. In a continuous foaming process, the polyolefin composition is melted and laden with gas in an extruder under pressures typically above 20 bar before being extruded through a die where the pressure drop causes the formation of a foam. The mechanism of foaming polypropylene in such foam extrusion process is explained, for example, in H. E. Naguib, C. B. Park, N. Reichelt, Fundamental foaming mechanisms governing the volume expansion of extruded polypropylene foams, Journal of Applied Polymer Science, 91, 2661-2668 (2004). Processes for foaming are outlined in S. T. Lee, Foam Extrusion, Technomic Publishing (2000). In a discontinuous foaming process, the polyolefin composition (micro-) pellets are laden with foaming agent under pressure and heated below melting temperature before the pressure in the autoclave is suddenly relaxed. The dissolved foaming agent forms bubbles and creates a foam structure.

Preferably the foamed sheet of the invention is prepared by a foam extrusion process.

The amount of blowing agent for example depends on the desired density and the polymer composition used. For example, the blowing agent may be used in an amount ≥0.10 wt % and ≤20 wt % based on the polyolefin composition.

Examples of suitable physical blowing agents include, but are not limited to isobutane, CO2, pentane, butane, nitrogen and/or a fluorohydrocarbon. Preferably, the physical blowing agent is isobutane and/or CO2.

Examples of suitable chemical blowing agents include, but are not limited to citric acid or a citric acid-based material (e.g. mixtures of citric acid and sodium bicarbonate) and azo dicarbonamide. Such chemical blowing agents are for example commercially available from Clariant Corporation under for example the name Hydrocerol™ CF-40E™ or Hydrocerol™ CF-05E™.

The invention further provides a process for the preparation of the foamed sheet according to the invention, comprising the sequential steps of:
a) providing the polyolefin composition,
b) adding a blowing agent to the polyolefin composition, for example wherein the blowing agent is added in an amount ≥0.10 wt % and ≤20 wt % based on the polyolefin composition,
c) subjecting the mixture of the polyolefin composition and the blowing agent to a foaming process, preferably a foam extrusion process to form the foamed sheet and optionally d) stretching the foamed sheet in at least one direction.

Preferably, step a) comprises melt-mixing the high density polyethylene composition and the low density polyethylene composition and optionally components such as nucleating agent and/or additives.

The invention also relates to the foamed sheet of the invention, which foamed sheet is stretched in at least one direction, for example the invention relates to the foamed sheet of the invention, wherein the foamed sheet is monoaxially stretched (for example in the machine direction) or for example, the invention relates to the foamed sheet of the invention wherein the foamed sheet is biaxially stretched, for example in both the machine direction (MD) and in the transverse direction (MD). As is known to the person skilled in the art, the stretching in MD and TD may be carried out simultaneously, or in consecutive steps.

The draw ratio in MD may for example be ≥1.1 and ≤7.0, for example ≥1.1 and ≤3.0. The draw ratio in transverse direction may for example be ≥1.1 and ≤7.0, for example ≥1.1 and ≤3.0.

The articles, in particular sheets of the invention can suitably be used in applications such as building and construction, automotive applications, household applications, such as food packaging and protective packaging; and consumer applications. For example, the articles, in particular sheets can be used for the preparation of cups, trays, containers, bottles, seals, returnable boxes. Other applications of the articles, in particular sheets of the invention are for example: sandwich panels, pipe insulations, concrete joint fillers, insulation materials for houses, water tanks or floors (floor underlayments).

In another aspect therefore, the invention relates to an article comprising the foamed sheet of the invention. In yet another aspect, the invention relates to use of the foamed sheet of the invention in applications such as building and construction, automotive applications, household applications, such as food packaging and protective packaging; and consumer applications.

The invention also relates to the use of the foamed sheet of the invention for the preparation of an article, for example wherein the article is a cup, tray, container, bottle, seal, reusable boxes, a sandwich panel, a pipe insulation, a concrete joint filler, an insulation material for houses, water tanks or floors (floor underlayments), footwear, a protective guard, a (sports) floor mat or a foam roller.

The sheets can be used as a replacement for applications wherein polystyrene foam is typically used, such as disposable food containers.

The invention further provides a multi-layer system comprising at least three layers A, B and C in this order, wherein the layer B is the foamed sheet according to the invention, and preferably
the layer A comprises a polyethylene composition A, for example comprising LDPE, LLDPE and/or HDPE, preferably the polyethylene composition A having a density of ≥0.940 and ≤0.970 g/cm³ and/or
the layer C comprises a polyethylene composition C, for example comprising LDPE, LLDPE and/or HDPE, preferably the polyethylene composition C having a density of ≥0.940 and ≤0.970 g/cm³,
the density being determined in accordance with ISO 1183-1 (2019).

Preferably, the multi-layer system consists of layers A, B and C.

Examples of the multi-layer system include a cup, tray, container, bottle, seal, reusable boxes, a sandwich panel, a pipe insulation, a concrete joint filler, an insulation material for houses, water tanks or floors (floor underlayments), footwear, a protective guard, a (sports) floor mat or a foam roller.

The polyethylene composition A may for example comprise a homopolymer of ethylene, or a copolymer of ethylene and an α-olefin selected from 1-butene, 1-hexene, 4-methyl-1-pentene, and 1-octene e.g. in an amount of ≥80.0 wt %, preferably ≥90.0 wt % with respect to the total weight of the polyethylene composition A. The amount of the moieties derived from 1-butene, 1-hexene, 4-methyl-1-pentene and 1-octene with regard to the copolymer may e.g. be ≤5.0 wt %.

The polyethylene composition C may for example comprise a homopolymer of ethylene, or a copolymer of ethylene and an α-olefin selected from 1-butene, 1-hexene, 4-methyl-1-pentene, and 1-octene e.g. in an amount of ≥80.0 wt %, preferably ≥90.0 wt % with respect to the total weight of the polyethylene composition C. The amount of the moieties derived from 1-butene, 1-hexene, 4-methyl-1-pentene and 1-octene with regard to the copolymer may e.g. be ≤5.0 wt %.

It is noted that the invention relates to the subject-matter defined in the independent claims alone or in combination with any possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### Materials

Post-consumer mechanically recycled
high density polyethylene composition

| | | PCR1 | PCR2 |
|---|---|---|---|
| Density | kg/m³ | 968.6 | 957.2 |
| MFR2@190 °C, 2.16 kg | g/10 min | 0.28 | 0.38 |
| MFR5@190 °C, 5 kg | g/10 min | 1.3 | 1.86 |
| MFR21@190 °C, 21.6 kg | g/10 min | 38 | 42 |
| MFR21/MFR2 | | 136 | 111 |
| Compositional analysis | | | |
| by ¹³C NMR | | | |
| PP | wt % | 1.8 | 0.6 |
| C4 | wt % | 0.3 | 0.2 |
| C6 | wt % | 0.3 | 0.3 |
| C8 | wt % | 0.1 | 0.1 |
| EVA | wt % | | |
| PET | wt % | 0.4 | 0.1 |

C4, C6, C8 each indicates the amount of C4, C6 or C8 moieties in the high density polyethylene composition, respectively.

PP indicates polypropylene.

EVA indicates ethylene vinyl acetate.

PET indicates polyethylene terephthalate.

LDPE

| | | SABIC ® | SABIC ® |
|---|---|---|---|
| | | LDPE | LDPE |
| | | 2600H0 | 2102X0 |
| Density | kg/m³ | 926 | 921 |
| MFR2@190 °C, 2.16 kg | g/10 min | 0.3 | 1.9 |
| MFR5@190 °C, 5 kg | g/10 min | 1.37 | |
| MFR21@190 °C, 21.6 kg | g/10 min | 30.99 | |
| MFR21/MFR2 | | 103 | |

Virgin HDPE

| | | SABIC ® | SABIC ® |
|---|---|---|---|
| | | HDPE | HDPE |
| | | B5823 | B6246LS |
| Density | kg/m³ | 958 | 962 |
| MFR2@190 °C, 2.16 kg | g/10 min | 0.16 | 0.50 |
| MFR5@190 °C, 5 kg | g/10 min | 0.89 | 2.5 |
| MFR21@190 °C, 21.6 kg | g/10 min | 23 | 46 |
| MFR21/MFR2 | | 144 | 92 |

MFR in the above tables are values determined according to ISO1133-1:2011.

Nucleator: POLYBATCH FPE 50 T NAT (masterbatch of talc in LDPE obtained from Lyondell-Basell)

### ¹³C NMR

Approximately 150 mg of the sample is added in a 10 mm NMR tube. Approx. 2-3 ml tetrachloroethane-d2 stabilized with BHT (7 mg/20 ml) is added to the tube. The tube is placed in a Buchi oven that is operating at 130 °C. The tube is rotated with approximately 20 rpm until the sample is dissolved completely. During dissolution, the sample is regularly homogenized by a glass-coated metal bar which is added to the solution and moved with a strong magnet on the outside of the NMR tube. Before inserting the sample in the NMR spectrometer, the glass-coated metal bar is removed from the sample tube and the sample is flushed with N₂. The 13C NMR spectrum is measured under suitable conditions on a high-field NMR spectrometer, equipped with a 10 mm cryo-cooled probehead. The number of branches and polymeric impurities are calculated from the integrals of various peaks corresponding to these branches/impurities.

### Preparation of Foamed Sheets

Compositions shown in Table 1 were melt mixed and foamed sheets were prepared. Foam density was determined in accordance with the method of ISO 845 (2006) as shown in Table 1.

The preparation of the foamed sheets was performed on a 30 mm double screw foam extruder from Theysohn having a length over diameter ratio (l/d) of 40. The extruder consists of nine electrical heating zones equipped with water cooling followed by a cooling section, static mixer and a die. CO2 was added as the physical blowing agent in an amount of 0.48 wt %. A 35 mm slit die with an adjustable die gap was used for the production of the foamed sheets. The die pressure was regulated by adjusting the die gap such that the pressure in front of the die was 30 bar. The foamed sheet was transported via rollers and a double belt-pulling unit. After the pulling unit, the foamed samples were collected for analyses.

TABLE 1

| | Foam density (kg/m³) | | | | |
|---|---|---|---|---|---|
| | | Ex 2 | Ex 3 | | |
| | | 78% | 68% | | |
| | | PCR2/ | PCR2/ | | |
| | CEx 1 | 20% | 30% | CEx 4 | CEx 5 |
| | 98% | LDPE | LDPE | 98% | 98% |
| Melt | PCR2/ | 2102X0/ | 2102X0/ | B5823/ | B6246LS/ |
| cooler set | 2% | 2% | 2% | 2% | 2% |
| point (°C) | nucleator | nucleator | nucleator | nucleator | nucleator |
| 180 | 552 | 449 | 382 | | |
| 170 | 544 | 461 | 351 | | |
| 165 | — | — | — | 600 | 542 |
| 160 | 575 | 378 | 347 | 574 | 522 |
| 150 | 487 | 338 | 334 | 556 | 489 |

Despite the presence of impurities, the foamed sheets of Ex 2-3 had an appearance similar to that of CEx 1, 4 and 5.

Foamed sheets made from the compositions of Ex 2-3 comprising a post-consumer HDPE and LDPE show a lower foam density than those made from the composition of CEx 1 and CEx 4-5 not comprising LDPE. Further, the deviations in the foam density of the foamed sheets made from the compositions of Ex 2-3 are relatively small over the processing temperature.

From Ex 2 and 3, it can be understood that a higher amount of LDPE results in a lower foam density.

### Mechanical Properties of Compositions

The compositions of Table 2 were molded into 1 mm plaques via the procedure below:
Fill mold (10×10 cm) with +/−12 gram granulate.
Place the mold inside the press.
Close the press with a force of 10 kN.
Increase the temperature from the compression plates to 180 °C.
After reaching the temperature set point, wait for 5 minutes.
Increase pressure to 100 kN for 5 minutes.
Cool down the sample before extracting from the mold.

### Extensional Viscosity and Strain Hardening

The extensional viscosity of the samples was measured at a fixed temperature of 175 °C and at three different strain rates: 0.5, 1.0 and 5.0 s⁻¹.

The strain hardening as a function of time and Hencky strain rate was calculated from the extensional viscosity measurements, (see the equation below) where η_{E} (t, ε_{\dot{H}}) is the transient extensional viscosity as a function of time and Hencky strain rate and η_{E0} (t) is the transient extensional viscosity in the linear viscoelastic regime, which can be determined in two different but equivalent ways: as three times the transient shear viscosity growth curve at very low strain rates or by extrapolating the superimposed portion of the extensional curves for different strain rates.

SH(t,ε_{\dot{H}})=η_{E}(t,ε_{\dot{H}})/3ηE₀(t)

The strain hardening at 0.5, 1.0 and 5.0 s⁻¹ and at a determined time (@ 4.8 s; 2.8 s and 0.5 s respectively) was calculated for all the materials under analysis.

### Flexural Modulus

Sample dimensions from injection molded bars produced on a Babyplast injection molding machine:
Length (l): 63.5 mm
Width (b): 12.7 mm
Thickness (h): 3.2 mm

The bars are tested on a universal testing machine according to ISO-178:

### Test Set-Up:

Span length (L): 51.2 mm
Test speed: 2 mm/min

TABLE 2

| | | Flexural modulus (MPa) |
|---|---|---|
| CEx 6 | 100% PCR1 | 951 |
| Ex 7 | 90% PCR1/ | 847 |
| | 10% LDPE 2600H0 | |
| Ex 8 | 80% PCR1/ | 841 |
| | 20% LDPE 2600H0 | |
| Ex 9 | 70% PCR1/ | 726 |
| | 30% LDPE 2600H0 | |
| Ex 10 | 100% B5823 | 1045 |

From Table 2, it can be understood that the addition of LDPE lowers the flexural modulus.

The addition of LDPE to the post-consumer mechanically recycled HDPE composition comprising impurities results in a good foam. In addition, improvements in extensional viscosity and strain hardening were observed.

1. A foamed article comprising a polyolefin composition having a density of ≥0.940 and ≤0.970 g/cm³ determined in accordance with ISO 1183-1 (2019), wherein the polyolefin composition comprises
a high density polyethylene composition having a density of >0.940 and ≤0.970 g/cm³ determined in accordance with ISO 1183-1 (2019) and
a low density polyethylene composition having a density of ≥0.917 and <0.940 g/cm³ determined in accordance with ISO 1183-1 (2019),
wherein the high density polyethylene composition comprises polypropylene and the amount of polypropylene with regard to the total weight of the polyolefin composition is ≥0.01 and ≤15.0 wt %.

2. The foamed article according to claim 1, wherein the high density polyethylene composition is or comprises a post-consumer mechanically recycled composition.

3. The foamed article according to claim 1, wherein the amount of polypropylene with regard to the total weight of the high density polyethylene composition is ≥0.01 and ≤20.0 wt %.

4. The foamed article according to claim 1, wherein the high density polyethylene composition comprises ≥0.01 wt % and ≤1.0 wt % of polyethylene terephthalate, ≥0.01 wt % and ≤1.0 wt % of C4 moieties, ≥0.01 wt % and ≤1.0 wt % of C6 moieties, and/or ≥0.01 wt % and ≤1.0 wt % of C8 moieties, with regard to the high density polyethylene composition.

5. The foamed article according to claim 1, wherein the high density polyethylene composition comprises a high density propylene having a density of >0.940 and ≤0.970 g/cm³ determined in accordance with ISO 1183-1 (2019) in an amount of ≥95.0 wt % with regard to the high density polyethylene composition,
the amount of low density polyethylene with regard to the total weight of the low density polyethylene composition is at least 95 wt %,
the total amount of the high density polyethylene composition, the low density polyethylene composition, an optional nucleating agent and optional additives with regard to the total weight of the polyolefin composition is 100 wt %.

6. The foamed article according to claim 1, wherein the low density polyethylene composition has a density determined in accordance with ISO 1183-1 (2019) of ≥0.917 and <0.940 g/cm³ and/or a melt mass-flow rate as determined in accordance with ISO 1133-1 (2011) at 190 °C and 2.16 kg load of ≥0.10 and ≤5.0 g/10 min.

7. The foamed article according to claim 1, wherein
the amount of the high density polyethylene composition with regard to the total weight of the polyolefin composition is 60 to 99 wt %, and
the amount of the low density polyethylene composition with regard to the total weight of the polyolefin composition is 1 to 40 wt %.

8. The foamed article according to claim 1, wherein the polyolefin composition further comprises a nucleating agent.

9. The foamed article according to claim 1, wherein the polyolefin composition has
a melt mass-flow rate MFR₂ as determined in accordance with ISO 1133-1 (2011) at 190 °C and 2.16 kg load of MFR2) of ≥0.05 and ≤10.0 g/10 min, and/or
a melt mass-flow rate MFR5 as determined in accordance with ISO 1133-1 (2011) at 190 °C and 5.0 kg load of ≥0.10 and ≤15.0 g/10 min, and/or
a melt mass-flow rate MFR21 as determined in accordance with ISO 1133-1 (2011) at 190 °C and 21.6 kg load of ≥5.0 and ≤50 g/10 min, of ≥7.0 and ≤45.0 g/10 min.

10. The foamed article according to claim 1, wherein the foamed article has a foam density of ≥0.20 and ≤0.80 g/cm³, as determined in accordance with the method of ISO 845 (2006).

11. The foamed article according to claim 1, wherein the foamed article is a foamed sheet, wherein the foamed sheet has a thickness of ≥50 μm and ≤100 cm.

12. A process for the preparation of the foamed article according to claim 1, comprising the sequential steps of:
a) providing the polyolefin composition,
b) adding a blowing agent to the polyolefin composition, and
c) subjecting the mixture of the polyolefin composition and the blowing agent to a foaming process.

13. The process according to claim 12, wherein the foamed article is a foamed sheet and step c) is a foam extrusion process to form the foamed sheet and the process optionally comprises d) stretching the foamed sheet in at least one direction.

14. A process according to claim 12, wherein step a) comprises melt-mixing the high density polyethylene composition and the low density polyethylene composition.

15. A multi-layer system comprising at least three layers A, B and C in this order, wherein the layer B is the foamed sheet according to claim 1.
